(19) United States
(12) Patent Application Publication
(10) Pub. No.: US 2020/0124898 A1
(43) Pub. Date: Apr. 23, 2020

(54) DISPLAY PANEL AND DISPLAY DEVICE

(71) Applicant: HKC CORPORATION LIMITED, Shenzhen, Guangdong (CN)

(72) Inventor: Beizhou Huang, Shenzhen (CN)

(21) Appl. No.: 16/312,773

(22) PCT Filed: Dec. 6, 2018
(86) PCT No.: PCT/CN2018/119566

§ 371 Date: Dec. 21, 2018

(30) Foreign Application Priority Data
Oct. 22, 2018 (CN) 201821714005.0

(51) Int. Cl. G02F 1/1345; G02F 1/1333

(52) U.S. Cl. CPC G02F 1/13452; G02F 1/133305

(57) ABSTRACT

A display panel includes a control board, an array substrate, and a circuit board. The display panel further includes a buffer configured to buffer force between the control board and the array substrate, and the buffer is disposed between the control board and the array substrate and at one side of the circuit board.

### CROSS-REFERENCES TO RELATED APPLICATION

This application is the International Application No. PCT/CN2018/119566 for entry into US national phase with an international filing date of Dec. 6, 2018 designating US, now pending, and claims priority to Chinese Patent Application 201821714005.0, filed with the Chinese Patent Office on Oct. 22, 2018 and entitled “display panel and display device”, the content of which is incorporated herein by reference in its entirety.

### BACKGROUND

### Technical Field Related Art

Embodiments of the present disclosure relate to the field of display technologies, and in particular, to display panel and display device.

### Related Art

The descriptions herein merely provide background information related to the present disclosure and do not necessarily constitute prior art. In recent years, the development of liquid crystal display devices has shown a trend of high integration and low cost. A common display device is usually a thin film transistor liquid crystal display (TFT-LCD). In such a liquid crystal display device, the liquid crystal panel is connected to a print circuit board (PCB) through a chip-on-flex (COF) to realize signal conversion. The COF is a flexible sheet on which wires are disposed.

The COF boards in the current display panel are usually located at both ends of the PCB. When the entire display device is subjected to vibration during testing or transportation, vibration is generated at both ends of the PCB, which easily causes the COF located at the outside to be pulled, causing the COF to be distorted, and the quality of the liquid crystal display device is therefore affected.

### SUMMARY

In an embodiment of the present disclosure, it is provided a display panel which includes:

an array substrate;

a control board spaced apart from and disposed opposite to one side of the array substrate;

a circuit board disposed between the control board and the array substrate and configured to electrically connect the control board with the array substrate; and

at least one buffer disposed between the control board and the array substrate to buffer force between the control board and the array substrate.

In an embodiment, the control board is disposed in parallel with the array substrate.

In an embodiment, the number of the at least one buffer is one, and both ends of the buffer are respectively connected to the control board and the array substrate.

In an embodiment, the number of the at least one buffer is four, and the buffers are respectively distributed at four corners of the circuit board.

In an embodiment, the number of the at least one buffer is one, and the buffer is connected between the circuit board and the control board or is connected between the circuit board and the array substrate.

In an embodiment, the number of the at least one buffer is two, one of the buffers is connected between the circuit board and the control board, and the other of the buffers is connected between the circuit board and the array substrate.

In an embodiment, a width of the buffer is smaller than a width of the circuit board in a direction perpendicular to a connection direction between the control board and the array substrate.

In an embodiment, the buffer is a flexible film disposed to buffer force between the control board and the array substrate.

In an embodiment, the flexible film is a film layer having insulating properties.

In an embodiment, the flexible film is a film layer having elastic properties.

In an embodiment, the flexible film is rectangular or square.

In an embodiment, the flexible film is integrally connected with the array substrate and the control board.

In another embodiment of the present disclosure, it is provided a display panel which includes:

an array substrate;

a control board spaced apart from and disposed opposite to one side of the array substrate;

at least one circuit board disposed between the control board and the array substrate and configured to electrically connect the control board with the array substrate; and

a pair of buffers disposed between the control board and the array substrate and located at opposite sides of the circuit board, wherein two ends of the pair of buffers are respectively connected to the control board and the array substrate to buffer force between the control board and the array substrate;

wherein the buffer is a flexible film or an elastic film, and a dimension of the buffer in a connection direction between the array substrate and the control board is greater than a dimension of the circuit board in the connection direction between the array substrate and the control board.

In an embodiment, the number of the at least one circuit board is two, and each of the circuit boards is disposed between the pair of the buffers, and two ends of each of the circuit boards are respectively connected to the control board and the array substrate.

In an embodiment, the flexible film or the elastic film is integrally connected to the circuit board.

In an embodiment, the flexible film or the elastic film is bonded or coated on the circuit board.

An object of the present disclosure is to provide a display device, including a display panel which includes:

an array substrate;

a control board spaced apart from and disposed opposite to one side of the array substrate;

at least one circuit board disposed between the control board and the array substrate and configured to electrically connect the control board with the array substrate; and

a pair of buffers disposed between the control board and the array substrate and located at opposite sides of the circuit board, wherein two ends of the buffer are respectively connected to the control board and the array substrate to buffer force between the control board and the array substrate;

wherein the buffer is a flexible film or an elastic film, and a dimension of the buffer in a connection direction between the array substrate and the control board is greater than a dimension of the circuit board in the connection direction between the array substrate and the control board.

In the display panel according to some embodiments of the present disclosure, by providing a buffer between the control board and the array substrate and disposing the buffer at one side of the circuit board, when the entire device is subjected to vibration during testing or transportation, the buffer 4 can withstand external stress, thereby buffering the force between the control board 2 and the array substrate 1, so that the circuit board 3 is protected from being damaged by pulling.

### BRIEF DESCRIPTION OF THE DRAWINGS

In order to more clearly illustrate the technical solutions in the embodiments of the present disclosure, the drawings used in the embodiments or the prior art description will be briefly described below. It is obvious that the drawings in the following description are only some embodiments of the present disclosure. To those skilled in the art, other drawings may be obtained from these drawings without paying any creative effort.

FIG. 1 is a schematic structural view of a display panel without a buffer according to an embodiment of the present disclosure;

FIG. 2 is a schematic structural view of a display panel according to an embodiment of the present disclosure;

FIG. 3 is a schematic structural view of a display panel according to an embodiment of the present disclosure;

FIG. 4 is a schematic structural view of a display panel according to an embodiment of the present disclosure;

FIG. 5 is a schematic structural view of a display panel according to an embodiment of the present disclosure;

FIG. 6 is a schematic structural view of a display panel according to an embodiment of the present disclosure;

FIG. 7 is a schematic structural view of a display panel according to an embodiment of the present disclosure;

FIG. 8 is a schematic structural view of a display panel according to an embodiment of the present disclosure; and

FIG. 9 is a schematic structural view of a circuit board according to an embodiment of the present disclosure.

### DESCRIPTION OF THE EMBODIMENTS

The technical solutions in the embodiments of the present disclosure will be clearly described in the following with reference to the accompanying drawings in the embodiments of the present disclosure. It is obvious that the embodiments to be described are just some instead of all embodiments of the present disclosure. All other embodiments obtained by those skilled in the art based on the embodiments of the present disclosure without paying any creative effort should be included within the protection scope of the present disclosure.

The term “comprise” and its variations in the specification, claims and above description of the drawings of the present disclosure are intended to cover non-exclusive inclusions. For example, a process, method or system, product or device including a series of steps or units is not limited to the listed steps or units, but optionally also includes steps or units not listed, or optionally also includes other steps or units inherent to the process, method, product or equipment. Moreover, the terms “first”, “second” and “third,” etc. are used to distinguish different objects, and are not intended to describe a particular order.

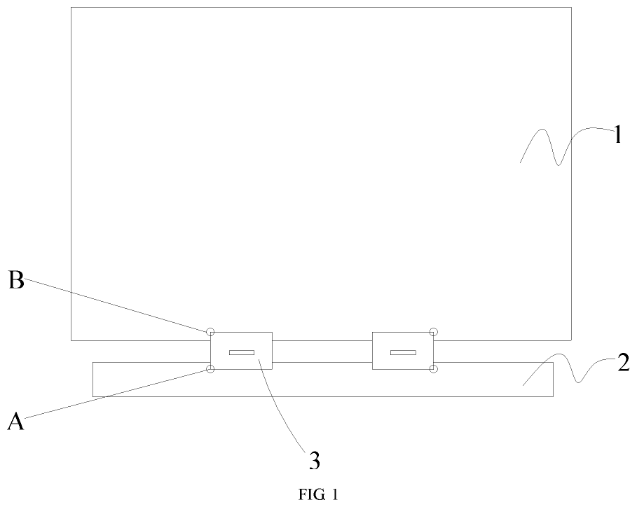

As shown in FIG. 1 to FIG. 9, in an embodiment of the present disclosure it is provided a display panel which includes a control board 2 and an array substrate 1. The control board 2 is disposed opposite to the array substrate 1. A circuit board 3 is mounted between the control board 2 and the array substrate 1. The circuit board 3 is disposed between the control board 2 and the array substrate 1, and the circuit board 3 may be configured to process the signal generated by the control board 2 and transmit the processed signal for driving to the array substrate 1 so as to generate various types of images. Further, the display panel further includes a buffer 4 disposed between the control board 2 and the array substrate 1 and located at one side of the circuit board 3. Thus, by providing a buffer 4 between the control board 2 and the array substrate 1 and disposing the buffer 4 at one side of the circuit board 3, when the entire device is subjected to vibration during testing or transportation, the buffer 4 can withstand external stress, thereby buffering the force between the control board 2 and the array substrate 1, so that the circuit board 3 is protected from being damaged by pulling.

In some applications, the above mentioned one side of the circuit board may be the upper side, the lower side, the left side or the right side of the circuit board 3, which is not limited herein.

In an application, the circuit board 3 is a flexible circuit board. Optionally, the flexible circuit board is a chip-on-film board. Of course, the flexible circuit board may be other type according to actual conditions and specific requirements, which is not limited herein.

As shown in FIG. 3, the control board 2 is disposed in parallel with the array substrate 1, so that the spacing between each pair of the buffer 4 and the circuit board 3 which are disposed between the control board 2 and the array substrate 1 is the same. When the circuit board 3 is subjected to external stress, the stress points will all on the pair of buffers 4. Since the height of the pair of buffers 4 is equal to the height of the circuit board 3, the force between the control board 2 and the array substrate 1 can be buffered, thereby further ensuring that the circuit board 3 is protected from external force and avoiding the problem that the quality of the device is affected because the circuit board 3 is damaged by the force. In addition, by configuring the pair of buffers 4 to be flush with the circuit board 3, it can be ensured that the utilization of the buffers 4 is maximized under the premise that the circuit board 3 is not subjected to the force. Of course, in the present embodiment, according to actual conditions and specific requirements, the height of the buffers 4 in the connection direction between the control board 2 and the array substrate 1 may be greater than the height of the circuit board 1 in the connection direction between the control board 2 and the array substrate 1, which is not limited here.

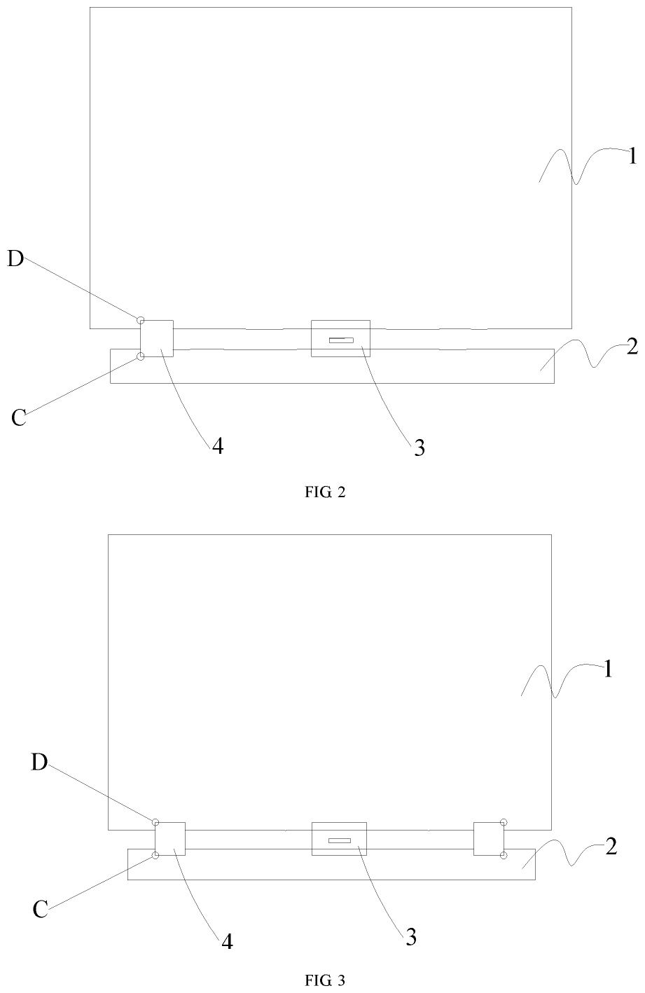

As shown in FIG. 2, the number of the buffer 4 is one, and both ends of the buffer 4 are respectively connected to the control board 2 and the array substrate 1. Thus, by disposing the buffer 4 between the control board 2 and the array substrate 1, when subjected to the external force, the force between the circuit board 3 and the control board 2 can be effectively buffered, thereby avoiding the problem that the quality of the device is affected because the circuit board 3 is damaged by the force.

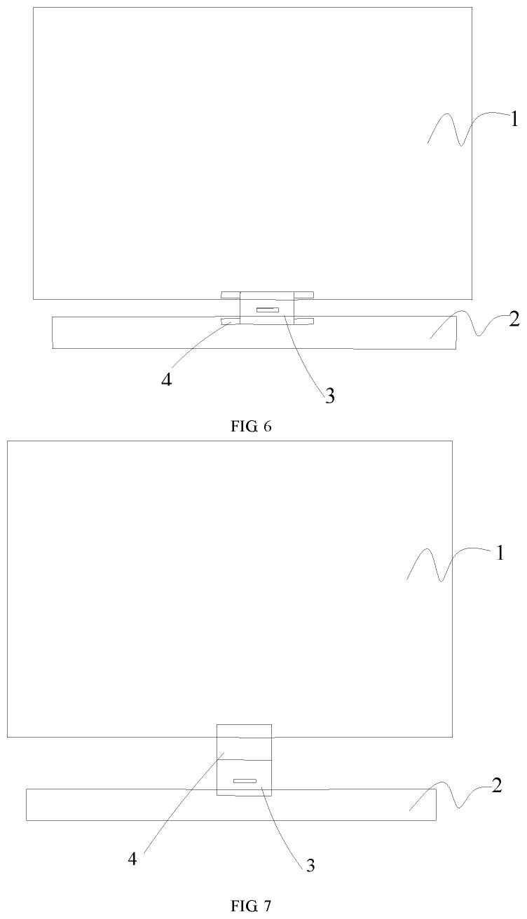

As shown in FIG. 6, the number of the buffers 4 is four, and the buffers 4 are distributed at four corners of the circuit board 3 respectively. Thus, by providing the buffers 4 at the four corners of the circuit board 3, when the circuit board 3 is subjected to external stress, the stress points are concentrated on the buffers 4, thereby effectively buffering the force between the control board 2 and the array substrate 1 and protecting the circuit board 3 from being pulled and damaged.

As shown in FIG. 7, the number of the buffer 4 is one, and the buffer 4 is connected between the circuit board 3 and the array substrate 1. By arranging the buffer 4 between the circuit board 3 and the array substrate 1, when external force is applied, the force between the circuit board 3 and the array substrate 1 can be effectively buffered, thereby avoiding the problem that the quality of the device is affected because the circuit board 3 is damaged by the force. Of course, in the embodiment, the buffer 4 is alternatively connected between the circuit board 3 and the control board 2 to effectively buffer the force between the circuit board 3 and the control board 2, thereby avoiding the problem that the quality of the device is affected because the circuit board 3 is damaged by the force.

As shown in FIG. 8, the number of the buffers 4 is two, and the buffers 4 are respectively distributed at two sides of the circuit board 3. Two ends of the buffers 4 are respectively connected to the control board 2 and the array substrate 1. In this way, by distributing the buffers 4 at two sides of the circuit board 3, it can be ensured that when the circuit board 3 is subjected to external stress, the force points are on the buffers 4, thereby effectively reducing the influence of the force between the control board 2 and the array substrate 1 on the circuit board 3 and protecting the circuit board 3 from being damaged.

As shown in FIG. 3, in the direction perpendicular to the connection direction between the control board 2 and the array substrate 1, the width of the pair of buffers 4 is smaller than the width of the circuit board 3. In this way, it is ensured that the space occupied by the pair of buffers 4 between the control board 2 and the array substrate 1 is saved on the premise that the circuit board 3 is not subjected to the force, thereby making the structure more compact.

In the application, the buffer 4 is provided as a flexible film, which has better cushioning performance and can be well matched with the flexible circuit board 3 so that no distortion or rupture occurs between the circuit board 3 and the buffer 4 when the force is applied. Thus, by selecting the flexible film, on one hand, the force between the control board 2 and the array substrate 1 can be better buffered, and on the other hand, the structural consistency of the buffer 4 and the circuit board 3 can be ensured, thereby further improving buffer performance. Of course, the buffer may alternatively be other structures according to actual conditions and specific requirements, which is not limited herein.

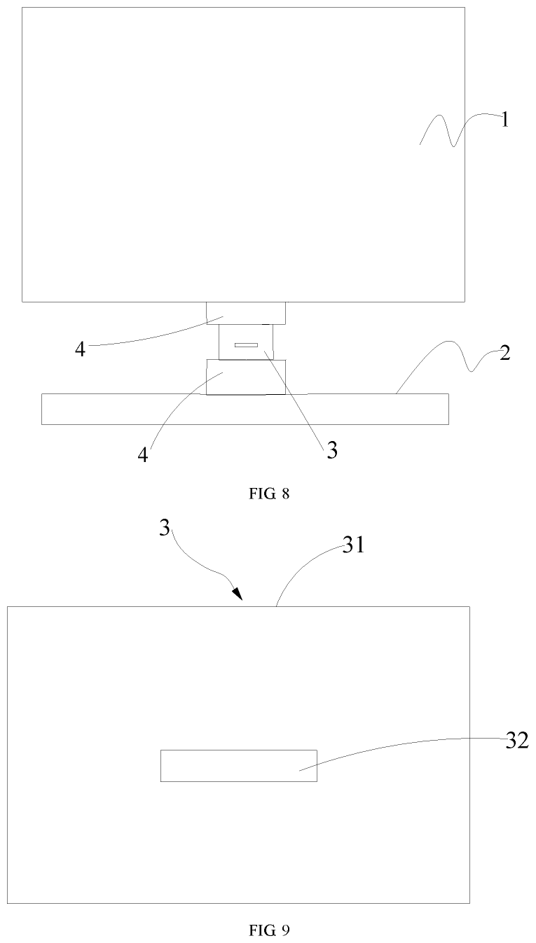

As shown in FIG. 9, the circuit board 3 has a substantially two-part structure, that is, a chip 32 and a film layer 31 disposed to cover the chip. The film layer 31 can be disposed as the flexible film of the buffer 4. Of course, in the embodiment, the flexible film may alternatively be other types of films according to actual conditions and specific requirements, which is not limited herein.

In an application, the flexible film is a film layer having insulating properties, and no metal trace is disposed on the flexible film. Thus, as the flexible film does not have any metal traces and has insulating properties, it can be avoided, when the soldering is finished, that the array substrate 1 is short-circuited, which affects the quality of the device.

In an application, the flexible film is a film layer having elastic properties. Thus, by providing the flexible film as a film layer having good elastic properties, when external stress is applied, better buffering function can be achieved, thereby more effectively protecting the circuit board 3.

In an application, the buffer 4 is arranged in a square shape, so that when the entire device is subjected to vibration during testing or transportation, the buffer 4 may have a large force receiving area to withstand external stress, thus effectively protecting the circuit board 3 from damage. Of course, in this embodiment, according to the actual conditions and specific requirements, the buffer 4 may alternatively be arranged in a rectangular shape, an elliptical shape, a circular shape, a ladder shape, a parallelogram shape, or in other shapes such as an irregular shape, which is no limit herein.

In an application, the flexible film is integrally connected to the array substrate 1 and the control board 2. In this way, the bonding force between the flexible film and the array substrate 1 and the control board 2 can be increased, and the service life of the flexible film can be improved. Of course, the flexible film may alternatively be bonded to the array substrate 1 and the control board 2 by bonding, or be disposed on the circuit board 3 in other manners, which is not limited herein.

In another embodiment of the present disclosure it is provided a display panel which includes a control board 2 and an array substrate 1. The control board 2 is disposed opposite to the array substrate 1. A circuit board 3 is mounted between the control board 2 and the array substrate 1. The circuit board 3 is disposed between the control board 2 and the array substrate 1, and the circuit board 3 may be configured to process the signal generated by the control board 2 and transmit the processed signal for driving to the array substrate 1 so as to generate various types of images. Further, the display panel further includes a pair of buffers 4 disposed between the control board 2 and the array substrate 1 and located at two sides of a pair of circuit boards 3. The buffers are flexible films and the dimension of the pair of buffers in the connection direction between the control board 2 and the array substrate 1 is greater than the dimension of the circuit board in the connection direction between the control board 2 and the array substrate 1. Thus, by providing the buffers 4 between the control board 2 and the array substrate 1, when the entire device is subjected to vibration during testing or transportation, the buffers 4 can withstand external stress, thereby buffering the force between the control board 2 and the array substrate 1, so that the circuit board 3 is protected from being damaged by pulling. By providing the buffers as flexible films, on one hand, the force between the control board 2 and the array substrate 1 can be better buffered, and on the other hand, the structural consistency of the buffer 4 and the circuit board 3 can be ensured, thereby further improving buffer performance. By configuring the dimension of the buffer structure 4 in the connection direction between the array substrate 1 and the control board 2 to be larger than the dimension of the circuit board 3 in the connection direction between the array substrate 1 and the control board 2, the contact areas between the buffers 4 and the control board 2 and the array substrate 1 are increased, thereby better buffering the force between the control board 2 and the array substrate 1.

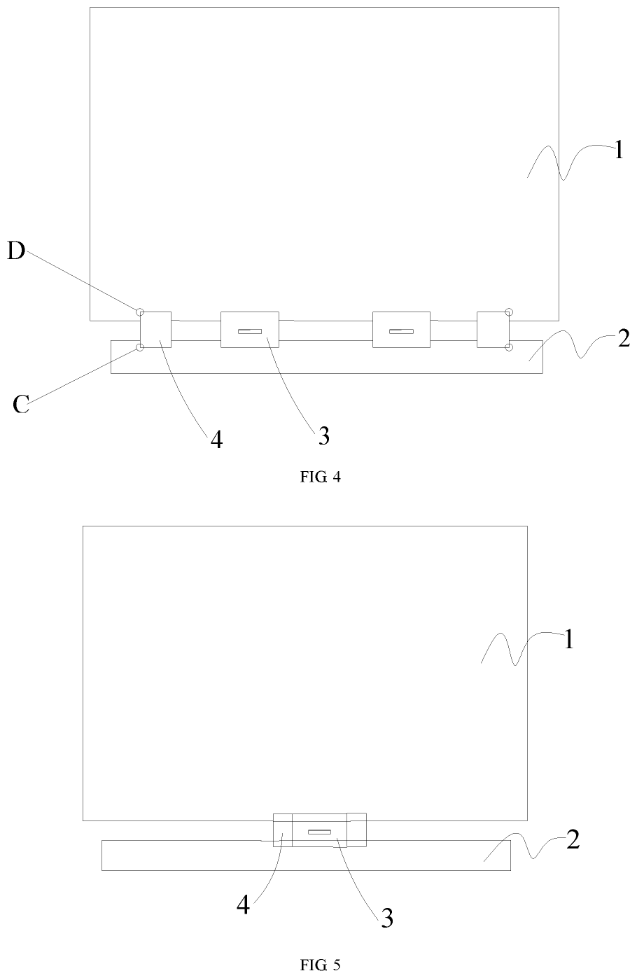

As shown in FIG. 4, the number of the circuit boards 3 is set to two, the circuit boards 3 are disposed between the pair of buffers 4, and two ends of each of the circuit boards 3 are respectively connected to the control board 2 and the array substrate 1. Thus, by arranging the circuit boards 3 between the pair of buffers 4, the force between the control board 2 and the array substrate 1 can be better buffered, and the circuit board 3 is protected from the force. Of course, in the embodiment, the number of the circuit boards 3 may alternatively be set to two or more than two, which is not limited herein.

In the present application, in order to more conveniently describe the pair of circuit boards 3 and the pair of buffers 4, the pair of circuit boards 3 are respectively named as a first circuit board and a second circuit board, and correspondingly, the pair of buffers are named as a first buffer and a second buffer.

As shown in FIG. 1 and FIG. 4, FIG. 1 is a schematic view of a display panel without adding the pair of buffers, and FIG. 4 is a schematic diagram of a display panel with the pair of buffers added. Thus, when the first circuit board is subjected to external stress, the stress points are the connection points between the first circuit board and the control board 2 and the array substrate 1, respectively, and are named as point A and point B, respectively. After the first buffer is added, when the external stress is applied, the stress points A and B are respectively transferred to the connection points between the first buffer and the control board 2 and the array substrate 1, where the connection point between the first buffer and the control board 2 is named as point C and the connection point of the first buffer and the array substrate 1 is named as point D, that is, the stress points are transferred from point A to point C and from point B to point D, thereby protecting the first circuit board from the external force. Correspondingly, the force principle of the second circuit board and the second buffer is the same as that of the first circuit board and the first buffer, and is not repeatedly described here.

In the present disclosure, the buffer 4 is a flexible film or an elastic film, and the flexible film or the elastic film is integrally connected to the circuit board 3. In this way, by configuring the flexible film or the elastic film to be integrally connected with the circuit board 3, the bonding force between the flexible film or the elastic film and the circuit board 3 can be increased, and force between the control board 2 and the array substrate 1 can be better buffered, which ensures that the circuit board 3 is protected from being damaged by force.

In an application, the flexible film or the elastic film is bonded on the circuit board 3. Of course, in the embodiment, the flexible film or the elastic film may alternatively be disposed on the circuit board 3 by coating, which is not limited here.

In an embodiment of the present disclosure it is provided a display device including the display panel as described above, which is not repeatedly described here.

The above description is only some embodiments of the present disclosure, and is not intended to limit the present disclosure. Any modifications, equivalent substitutions and improvements made within the spirit and principles of the present disclosure are included in the protection scope of the present disclosure.

1. Display panel, comprising:
an array substrate;
a control board spaced apart from and disposed opposite to one side of the array substrate;
a circuit board disposed between the control board and the array substrate and configured to electrically connect the control board with the array substrate; and
at least one buffer disposed between the control board and the array substrate to buffer force between the control board and the array substrate.

2. The display panel of claim 1, wherein the control board is disposed in parallel with the array substrate.

3. The display panel of claim 1, wherein the number of the at least one buffer is one, and both ends of the buffer are respectively connected to the control board and the array substrate.

4. The display panel of claim 1, wherein the number of the at least one buffer is four, and the buffers are respectively distributed at four corners of the circuit board.

5. The display panel of claim 1, wherein the number of the at least one buffer is one, and the buffer is connected between the circuit board and the control board or is connected between the circuit board and the array substrate.

6. The display panel of claim 1, wherein the number of the at least one buffer is two, one of the buffers is connected between the circuit board and the control board, and the other of the buffers is connected between the circuit board and the array substrate.

7. The display panel of claim 1, wherein a width of the buffer is smaller than a width of the circuit board in a direction perpendicular to a connection direction between the control board and the array substrate.

8. The display panel of claim 1, wherein the buffer is a flexible film disposed to buffer pulling force between the control board and the array substrate.

9. The display panel of claim 8, wherein the flexible film is a film layer having insulating properties.

10. The display panel of claim 8, wherein the flexible film is a film layer having elastic properties.

11. The display panel of claim 8, wherein the flexible film is rectangular or square.

12. The display panel of claim 8, wherein the flexible film is integrally connected with the array substrate and the control board.

13. The display panel, comprising:
an array substrate;
a control board spaced apart from and disposed opposite to one side of the array substrate;
at least one circuit board disposed between the control board and the array substrate and configured to electrically connect the control board with the array substrate; and
a pair of buffers disposed between the control board and the array substrate and located at opposite sides of the circuit board, wherein two ends of the pair of buffers are respectively connected to the control board and the array substrate to buffer force between the control board and the array substrate;
wherein the buffer is a flexible film or an elastic film, and a dimension of the buffer in a connection direction between the array substrate and the control board is greater than a dimension of the circuit board in the connection direction between the array substrate and the control board.

14. The display panel of claim 13, wherein the number of the at least one circuit board is two, and each of the circuit boards is disposed between the pair of the buffers, and two ends of each of the circuit boards are respectively connected to the control board and the array substrate.

15. The display panel of claim 13, wherein the flexible film or the elastic film is integrally connected to the circuit board.

16. The display panel of claim 13, wherein the flexible film or the elastic film is bonded or coated on the circuit board.

17. A display device, comprising a display panel which comprises:
an array substrate;
a control board spaced apart from and disposed opposite to one side of the array substrate;
at least one circuit board disposed between the control board and the array substrate and configured to electrically connect the control board with the array substrate; and
a pair of buffers disposed between the control board and the array substrate and located at opposite sides of the circuit board, wherein two ends of the buffer are respectively connected to the control board and the array substrate to buffer pulling force between the control board and the array substrate;
wherein the buffer is a flexible film or an elastic film, and a dimension of the buffer in a connection direction between the array substrate and the control board is greater than a dimension of the circuit board in the connection direction between the array substrate and the control board.
